(19) United States
(12) Patent Application Publication
(10) Pub. No.: US 2022/0389846 A1
(43) Pub. Date: Dec. 8, 2022

(54) CYLINDER HEAD COVER

(71) Applicant: Mahle International GmbH, Stuttgart (DE)

(72) Inventors: Tilo Hentschel, Hattenhofen (DE); Justus Himstedt, Stuttgart (DE); Antonio Menonna, Ditzingen (DE); Luis Neumann, Schorndorf (DE); Falk Schneider, Gerlingen (DE)

(21) Appl. No.: 17/834,927

(22) Filed: Jun. 7, 2022

(30) Foreign Application Priority Data
Jun. 8, 2021 (DE) 10 2021 205 753.5

(51) Int. Cl. F01M 9/10; F01L 1/047; F16C 33/66

(52) U.S. Cl. CPC F01M 9/102; F01L 1/047; F16C 33/6681; F01L 2001/0476

(57) ABSTRACT

A cylinder head cover of plastic for covering a cylinder head of an internal combustion engine is disclosed. The cylinder head cover includes a bearing track including at least two bearing points each having a bearing opening for supporting a camshaft. A bearing ring is provided in at least one of at least one bearing point and a bearing opening. The bearing ring is injected into the plastic of the cylinder head cover. An oil duct that leads to at least one of the two bearing points and serves for bearing lubrication is arranged in the cylinder head cover.

### CROSS-REFERENCE TO RELATED APPLICATION

This application claims priority to German Application No. DE 10 2021 205 753.5 filed on Jun. 8, 2021, the contents of which are hereby incorporated by reference in its entirety.

### TECHNICAL FIELD

The present invention relates to a cylinder head cover made of plastic for covering a cylinder head of an internal combustion engine. The invention moreover relates to an internal combustion engine comprising such a cylinder head cover.

### BACKGROUND

Due to ever increasing drive forces, a load of a camshaft in an internal combustion engine along with its bearing points also increases, which, in turn, makes it necessary to provide an improved lubricant supply. In known cylinder head covers, which, in addition to aluminum, are also made of plastic, lubricant, for example oil, is thereby guided through an oil gallery or generally through an oil duct, respectively, to bearing points of the camshaft and through the jacket surface thereof to a drive plug and a phase adjuster, for example. This usually takes place in the region of axial bearing rings. Oil is simultaneously also guided from the oil gallery to other bearing points, which take over, for example, a radial support of the camshaft.

In the case of the cylinder head covers known from the prior art, the comparatively high oil throughput in the individual bearing points is often a disadvantage.

The present invention thus deals with the problem of specifying an improved or at least an alternative embodiment for a cylinder head cover of the generic type, which in particular overcomes the disadvantages known from the prior art.

This problem is solved according to the invention by means of the subject matter of the independent claim(s). Advantageous embodiments are subject matter of the dependent claims.

### SUMMARY

The present invention is based on the general idea of forming a cylinder head cover as plastic injection molded part, and to already integrate therein at least one oil duct for lubricating or actuating, respectively, a camshaft supported in the cylinder head cover, and to simultaneously embed bearing rings for supporting the camshaft in the plastic of the cylinder head cover, in order to thus effect a reliable and improved lubrication of the camshaft in the individual bearing points and simultaneously an actuation thereof, for example of a phase adjuster of the camshaft. A pre-fabricated, high-quality and simultaneously cost-efficient product, which provides for a smooth and thus fuel-reducing support of the camshaft, can be created by means of the cylinder head cover, which is formed as plastic injection molded part, as well as the bearing rings embedded therein, or the at least one oil duct, respectively. The camshaft is thereby supported in at least two bearing points of the cylinder head cover, which form a bearing track.

In the case of an advantageous further development of the cylinder head cover according to the invention, two axially adjacent bearing rings, which limit a circumferential oil ring groove, which is arranged therebetween and which is connected to the oil duct so as to communicate therewith, are provided at at least one bearing point. In this case, the bearing point can be formed, for example, as axial bearing, wherein a combined axial/radial bearing can purely theoretically also be created by means of bearing rings, which are arranged axially adjacent to one another in this way. During a deburring of the cylinder head cover after the plastic injection molding process has ended, the circumferential oil ring groove, which is required for the oil supply of the camshaft, can be introduced, for example, by means of a corresponding cutting tool. During the introduction of the oil ring groove, a communicating connection to the oil duct can simultaneously also be created. By means of the injection of the bearing rings into the plastic of the cylinder head cover, they are firmly connected to said plastic at the same time, and are thus aligned and arranged in a captive manner.

The two bearing rings are advantageously formed of identical construction or of differing widths with respect to their axial width. In particular a formation of identical construction of the two bearing rings allows for common parts, which render the production and assembly process to be significantly more cost-efficient. It goes without saying that it is also conceivable thereby that the two bearing rings can be of differing widths, so that in this case, the oil duct does not enter into the circumferential oil ring groove in the axial middle with respect to the bearing point between the two bearing rings, but is shifted in the axial direction analogously to the axial widths of the respective bearing rings.

In the case of a further advantageous embodiment of the cylinder head cover according to the invention, at least one bearing ring has an axial bearing shoulder. By means of an axial bearing shoulder of this type, it is possible to form this bearing point as combined axial/radial bearing, wherein an axial support of the camshaft in both directions is made possible by means of two bearing rings of this type, which are arranged in a mirror-inverted manner, each comprising an axial bearing shoulder. In this case, the two axial bearing shoulders of the bearing rings are arranged between corresponding surfaces on, for example, a drive plug. Via the oil duct, an oil supply thereby takes place into a chamber of the drive plug, and from the latter, for example in the direction of a phase adjuster of the camshaft, which is arranged adjacent thereto and via which, for example, valve opening times can be set individually. The axial bearing shoulders of the bearing ring thereby reduce a rubbing wear of the axial bearing. In the case of a bearing ring of this type comprising an axial bearing shoulder, it is additionally conceivable that only the latter or a radial bearing region of the bearing ring, or the axial bearing shoulder as well as the radial bearing region are embedded in the plastic of the cylinder head cover. Provided that the bearing (made of metal here) protrudes beyond the plastic, this has the advantage that sealing can take place during the filling of an injection mold for producing the cylinder head cover made of plastic on the metal of the bearing. Less material is thus used and a later complex removal of plastic from regions, which are to be metallically blank (bearing surface in contact with the camshaft) can be forgone. The machining of in particular fiber-reinforced plastics weakens the material because it is torn open along the fibers.

A single bearing ring as well as a sealing ring axially adjacent thereto, which limit a circumferential oil ring groove, which is arranged therebetween and which is connected to the oil duct so as to communicate therewith, are advantageously provided at at least one bearing point. It is possible thereby to form the bearing ring as one-piece, cost-efficient radial bearing ring, which is in particular for example flush with a front surface of the bearing point. An unwanted escape of oil is prevented via the sealing ring, which is arranged adjacent thereto, whereby said oil can enter from the oil duct into the circumferential oil ring groove of the bearing point and can ensure a lubrication of the bearing point there and thus a smooth support of the camshaft.

In the case of an advantageous further development of the solution according to the invention, the sealing ring is held in a positive manner in a ring groove of the camshaft and/or of the bearing point. This provides for a comparatively simple assembly of the sealing ring and thus a comparatively simple completion of the bearing point. The sealing ring thereby only serves the purpose of preventing an uncontrolled escape of oil, and thus provides for a lubrication, which is required for a smooth running. In this case, the camshaft is slidingly supported with respect to the bearing point via the sealing ring.

It goes without saying that, in the alternative, it is also conceivable that the sealing ring is arranged in a non-positive manner or by means of a substance-to-substance bond at the bearing point. In this case, the sealing ring can be molded onto an inner jacket surface of the bearing point or onto an outer jacket surface of the camshaft. A surface of the sealing ring, which comes into contact with the bearing point, is thereby preferably larger than the surface of the sealing ring, which comes into contact with the outer jacket surface of the camshaft, provided that the sealing ring is firmly connected, for example adhered, to the inner jacket surface of the bearing point. In this case, the bearing ring as well as the sealing ring can terminate in a flat manner, that is, so as to be surface-flush, with a respective front side of the bearing point. It goes without saying that this also applies for all other radial bearing points.

In the case of a further advantageous embodiment of the cylinder head cover according to the invention, at least one bearing ring is formed in one piece or in several pieces, in particular of two bearing half-shells. A bearing ring of this type can thus be produced in a cost-efficient manner and simultaneously with a high quality, in particular in the case of a formation in one piece. In the case of a formation in several pieces, for example a simplified assembly, for example of the bearing half-shells in a plastic injection molding tool, can be attained.

At least one bearing ring advantageously protrudes beyond the corresponding bearing point in the axial direction. A radial bearing, which is widened compared to the bearing point, can be created thereby, whereby a particularly smooth support can be attained.

The present invention is further based on the general idea of equipping an internal combustion engine with at least one cylinder head cover according to the previous paragraphs as well as with a camshaft supported therein, wherein the camshaft has a drive plug, to which oil is applied via a bearing point. An internal combustion engine according to the invention, which is equipped with the cylinder head cover according to the invention, is characterized by a reduction of a required lubricant use and by a significantly improved steering of a lubricant flow in the entire bearing point region. In addition, an advantageous vibration behavior is attained by means of the changed support and the simultaneously improved lubrication of the camshaft. The reduction of material use and costs during the machining of the bearing track by means of the optimization of the surface area of the radial bearings represents further advantages.

In this case, the bearing point for storing the drive plug is formed, for example, as axial/radial bearing, wherein at least one of the bearing rings in said axial/radial bearing has an axial bearing shoulder for axially supporting the drive plug and further the camshaft. Oil can be applied to an oil chamber in the drive plug via the oil duct, which leads into the corresponding oil ring groove in this bearing point, and the oil can be transferred from there to the phase adjuster, in order to be able to set valve opening times, for example. In this case, the oil supply to the bearing simultaneously does not only serve the purpose of adjusting the valve opening times, but also of lubricating the bearing point.

On the longitudinal end located opposite the phase adjuster, the camshaft is advantageously closed by means of a plug. The plug can thereby be soldered, pressed, welded, adhered to the camshaft or can be firmly connected via a thermal shrink fit.

Further important features and advantages of the invention follow from the subclaims, from the drawings, and from the corresponding figure description on the basis of the drawings.

It goes without saying that the above-mentioned features and the features, which will be described below, cannot only be used in the respective specified combination, but also in other combinations, or alone, without leaving the scope of the present invention.

Preferred exemplary embodiments of the invention are illustrated in the drawings and will be described in more detail in the following description, whereby identical reference numerals refer to identical or similar or functionally identical components.

### BRIEF DESCRIPTION OF THE DRAWINGS

In each case schematically,

FIG. 1 shows a sectional illustration through a cylinder head cover according to the invention of an internal combustion engine according to the invention,

FIG. 2 shows a detail illustration of a possible bearing point,

FIG. 3 shows an illustration as in FIG. 2, but in the case of a differently formed bearing point and only a single bearing ring,

FIG. 4 shows an illustration as in FIG. 3, but in the case of a different sealing ring.

### DETAILED DESCRIPTION

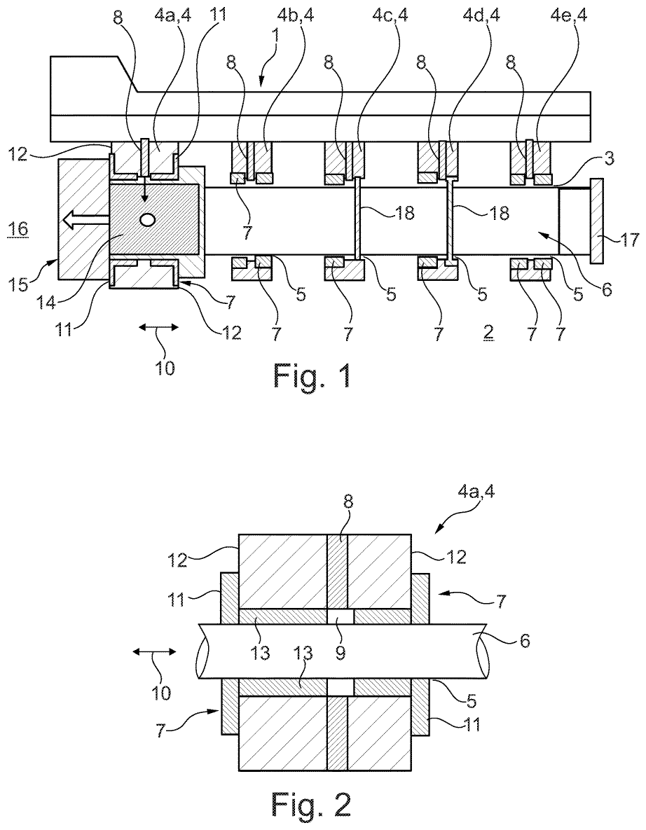

According to FIG. 1, a cylinder head cover 1 according to the invention made of plastic for covering a cylinder head of an internal combustion engine 2 according to the invention has a bearing track 3 comprising at least two bearing points 4a, 4b, 4c, 4d, and 4e, each comprising a bearing opening 5 for the support, in particular for the tunnel support, of a camshaft 6. In at least one of the bearing openings 5, a bearing ring 7 is thereby injected into the plastic of the cylinder head cover 1. An oil duct 8, which leads to at least one bearing point 4a to 4e and serves for the bearing lubrication, is furthermore arranged in the cylinder head cover 1.

Different options for the design of the respective bearing points 4a to 4e with the corresponding bearing rings 7 will now be discussed in more detail below. All embodiments thereby have in common that an improved bearing lubrication and thus also a reduction of an abrasion at the bearing points 4a to 4e can be minimized with them. A required lubricant quantity can simultaneously also be attained by means of an improved steering of the lubricant flow in the entire bearing point region. An advantageous vibration behavior is furthermore attained by means of the changed bearing according to the invention and the simultaneously improved lubrication of the camshaft 6. A machining of the bearing track 3 can also be designed to be less complex by means of the bearing rings 7, which are at least partially integrated in the plastic of the cylinder head cover 1.

When looking at the bearing point 4a according to FIG. 2, two axially adjacent bearing rings 7 can be recognized there, which limit a circumferential oil ring groove 9, which is arranged therebetween and which is connected so as to communicate with the oil duct 8. The two bearing rings 7 at the bearing point 4a according to FIG. 2 are thereby formed differently with respect to their axial width, whereby the oil duct 8 is not arranged in the middle of the bearing point 4a, viewed in the axial direction 10. It goes without saying that, purely theoretically, a formation of identical construction of the bearing rings 7 is also conceivable, so that in this case, the oil duct 8 and further also the oil ring groove 9 are arranged in the middle of the bearing point 4a in the axial direction 10.

The bearing point 4 of FIG. 2 thereby essentially corresponds to the bearing point 4a from FIG. 1, but wherein the axial width of the individual bearing rings 7 is different in FIG. 2, and identical in FIG. 1. In FIG. 1, the axial bearing shoulders 11 are additionally embedded in the lateral front surface 12 of the bearing point 4 and is surface-flush therewith, while they bear on the lateral front surface 12 according to FIG. 2.

When further looking at the bearing rings 7 of the bearing point 4a, it can be seen that they each have an axial bearing shoulder 11, so that the bearing point 4a is not only formed as radial bearing, but simultaneously also as axial bearing and thus as combined axial/radial bearing.

After the injection molding of the cylinder head cover 1, the bearing track 3 is post-processed, wherein for example injection molding burrs of the plastic or other overhangs are removed. The circumferential oil ring grove 9 can, for example, also be produced in this method step. The bearing rings 7 are usually made of metal, for example of an aluminum alloy. The bearing ring 7 used in the case of the bearing point 4a is formed in two pieces, wherein the axial bearing shoulders 11 abut on lateral front surfaces 12 of the bearing point 4a or are embedded in the plastic of the bearing point 4a there. The axial bearing shoulders 11 are thereby responsible for the axial support of the camshaft 6, while the radial bearing shoulders 13 of the bearing rings 7 or of the two-piece bearing ring 7, respectively, take over the radial support of the camshaft 6. It is conceivable thereby that the axial bearing shoulder 11 and/or the radial bearing shoulders 13 of the bearing ring(s) are/is embedded in the plastic of the cylinder head cover 1 in the region of the bearing point 4a.

According to FIG. 1, the oil duct 8 of the bearing point 4a opens out into the oil ring groove 9 and enters from there into a chamber 14 of a drive plug 15. From the chamber 14, in turn, the oil can be guided to a phase adjuster 16, and from there can be used for setting a valve opening time. On the side opposite the drive plug 15 or opposite longitudinal end, respectively, the camshaft 6 is closed by means of a plug 17, which is, for example, soldered, pressed, welded, adhered to the camshaft 6 or firmly connected via a thermal shrink fit.

An axial width of the oil ring groove 9 can be attained via an insertion of the integral or two-piece bearing ring 7 with a defined distance at a stop into an injection molding tool. The axial distance between two such bearing rings 7 can also be attained by means of a connection of the latter at at least one point.

When looking at the bearing point 4b according to FIG. 1, a two-piece bearing ring 7 or two such bearing rings 7, respectively, can be recognized there, which are surface-flush with the respective lateral front surface 12 of the bearing point 4b, and which are of identical width in the axial direction 10. This offers the large advantage that in this case, the two bearing rings 7 can be formed of identical construction and thus, for example, as common parts, whereby an improved support function with significantly reduced production effort and thus with significantly reduced production costs can be achieved.

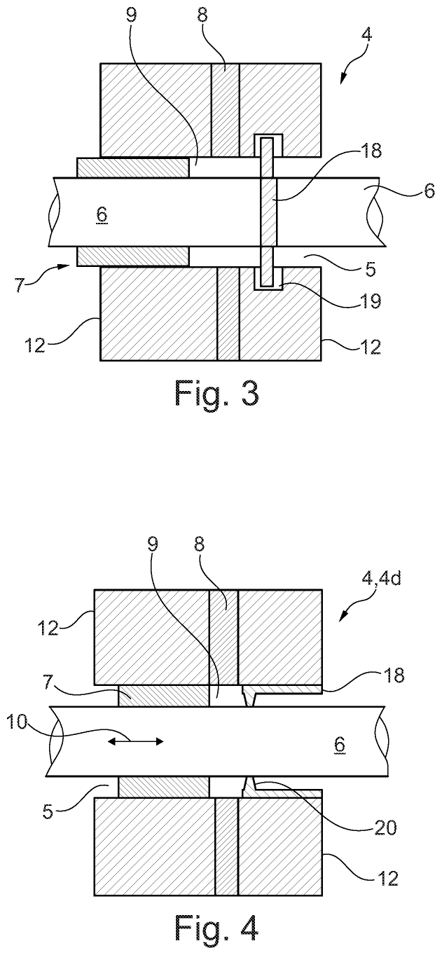

When looking at the bearing point 4c according to FIG. 1, a bearing ring 7 can be recognized there, which is formed integrally or in one piece, respectively. This bearing ring 7 is thereby arranged axially adjacent to the oil duct 8. According to the illustration in FIG. 1, the bearing ring 7 in the bearing point 4c is surface-flush with the lateral front surface 12 of the bearing point 4c, wherein another embodiment (see FIG. 3 or 4) is also conceivable, in the case of which the bearing ring 7 protrudes beyond the lateral front surface 12 in the axial direction (see FIG. 3) or in the case of which the lateral front surface 12 protrudes beyond the bearing ring 7 in the axial direction 10 (see FIG. 4) By means of the use of a one-piece bearing ring 7, for example in the bearing points 4c, 4d, as well as in FIGS. 3 and 4, a sealing ring 18 is additionally required, which provides for a limitation of the oil ring groove 9 on the side, which is not closed by the bearing ring 7.

The sealing ring 18 can thereby be arranged, for example, in a positive manner in a ring groove 19 of the camshaft 6 and/or of the bearing point 4. In the alternative, an embodiment as in FIG. 4 is also conceivable, in the case of which the sealing ring 18 is arranged in a non-positive manner or by means of a substance-to-substance bond at the bearing point 4, for example adhered thereto. By means of a ring shoulder 20, which protrudes in the direction of the camshaft 6, it glides on an outer jacket surface of the camshaft 6 and further seals the oil ring groove 9.

The embodiment of the bearing points 4 with additional sealing ring 18 can preferably be used in particular in the case of a high axial load or in the case of high pressures, respectively. There is additionally the advantage that with the sealing ring 18, the bearing point 4, 4d includes a groove/depression for the oil distribution and an oil transfer to the surrounding area is simultaneously sealed. The necessary oil volume flow for lubricating the bearing point 4, 4d is simultaneously smaller with the same effect. The sealing ring 18 can simultaneously serve as a seal against the surrounding area, which is to be kept in an oil-free manner, in particular with respect to a control drive, which is driven by means of a toothed belt.

The advantage of a one-piece bearing ring 7 or only of a single bearing ring 7 for each bearing point 4, respectively, lies in particular in reduced production costs, because a sealing ring 18 for sealing the oil ring grooves 9 can be produced and assembled more cost-efficiently. In the case of bearing rings 7, which protrude beyond the lateral front surface 12 of the corresponding bearing point 4 in the axial direction 10, a pressure load in the direction of the front surface 12 can be reduced. This also provides the advantage that in the case of bearing rings 7, which protrude beyond the plastic, sealing can take place during the filling of an injection mold for producing the cylinder head cover 1 made of plastic on the metal of the bearing ring 7. Less material is thus used and a later complex removal of plastic from regions, which are to be metallically blank (bearing surface in contact with the camshaft 6) can be forgone.

All things considered, a reduction of a material use and thus also a reduction of the costs when machining the bearing track 3 can be attained by means of the cylinder head cover 1 according to the invention and the bearing points 4 according to the invention by means of the optimization of the surface area of the bearing ring 7. A required lubricant use can simultaneously be attained by means of an improved steering of the lubricant flow in all bearing points 4a to 4e. By means of the improved support and simultaneously improved lubrication of the camshaft 6, an advantageous vibration behavior can also be attained.

1. A cylinder head cover of plastic for covering a cylinder head of an internal combustion engine, comprising:
a bearing track including at least two bearing points each of the at least two bearing points comprising a bearing opening for the supporting a camshaft,
a bearing ring provided in at least one of at least one of the two bearing points and the bearing opening of at least one of the two bearing points, the bearing ring being injected into the plastic of the cylinder head cover, and
an oil duct that leads to at least one of the two bearing points and serves for bearing lubrication.

2. The cylinder head according to claim 1, wherein the at least one bearing point includes two axially adjacent bearing rings that limit a circumferential oil ring groove, wherein the circumferential oil ring groove is arranged between the two bearing rings and is connected to the oil duct so as to communicate therewith.

3. The cylinder head cover according to claim 2, wherein the two bearing rings are structured one of identically and differently with respect to their axial width.

4. The cylinder head cover according to claim 2, wherein at least one of the two bearing rings has an axial bearing shoulder.

5. The cylinder head cover according to claim 1, wherein the at least one bearing point includes a single bearing ring and a sealing ring arranged axially adjacent to the single bearing ring, that limit a circumferential oil ring groove, wherein the oil ring groove is arranged between the single bearing ring and the sealing ring and is connected to the oil duct so as to communicate therewith.

6. The cylinder head cover according to claim 5, wherein the sealing ring is held in a positive manner in a ring groove of at least one of the camshaft and the at least one bearing point.

7. The cylinder head cover according to claim 5, wherein the sealing ring is arranged in a non-positive manner or via a substance-to-substance bond at the at least one bearing point.

8. The cylinder head cover according to one of the preceding claims, claim 1, wherein the bearing ring is formed in one piece or in several pieces.

9. The cylinder head cover according to claim 1, wherein the bearing ring protrudes beyond the at least one bearing point in an axial direction.

10. An internal combustion engine, comprising:
at least one cylinder head cover composed of plastic and a camshaft supported therein, the at least one cylinder head cover including:
a bearing track including at least two bearing points each having a bearing opening for supporting the camshaft;
a bearing ring provided in at least one of at least one of the two bearing points and the bearing opening of at least one of the two bearing points, the bearing ring being injected into the plastic of the at least one cylinder head cover;
an oil duct that leads to at least one of the two bearing points arranged in the at least one cylinder head cover to provide bearing lubrication; and
a drive plug and a phase adjuster, to which oil is applied via at least one of the two bearing points, are arranged at the camshaft.

11. The internal combustion engine according to claim 10, wherein the camshaft is closed via a plug on a longitudinal end located opposite to the phase adjuster.

12. The internal combustion engine according to claim 11, wherein the plug is soldered, pressed, welded, or adhered to the camshaft or firmly connected via a thermal shrink fit to the camshaft.

13. The internal combustion engine according to claim 10, wherein the bearing ring includes two axially adjacent bearing rings provided at the at least one bearing point that define a circumferential oil ring groove, wherein the circumferential oil ring groove is arranged between the two bearing rings and is connected to the oil duct.

14. The internal combustion engine according to claim 13, wherein the two bearing rings have an axial width that is different from one another.

15. The internal combustion engine according to claim 13, wherein at least one of the two bearing rings has an axial bearing shoulder.

16. The internal combustion engine according to claim 10, wherein the at least one bearing point includes the bearing ring and a sealing ring arranged axially adjacent to the bearing ring to define a circumferential oil ring groove, wherein the circumferential oil ring groove is arranged between the bearing ring and the sealing ring and is connected to the oil duct.

17. The internal combustion engine according to claim 16, wherein the sealing ring is held in a ring groove of at least one of the camshaft and the at least one bearing point.

18. The internal combustion engine according to claim 16, wherein the sealing ring is arranged via a substance-to-substance bond at the at least one bearing point.

19. The internal combustion engine according to claim 10, wherein the bearing ring protrudes beyond the at least one bearing point in an axial direction.

20. The internal combustion engine according to claim 10, wherein the bearing ring includes two bearing half-shells.
